(19) United States
(12) Patent Application Publication
(10) Pub. No.: US 2026/0340525 A1
(43) Pub. Date: Oct. 29, 2026

(54) Business Process Management Device and Business Process Management Method

(71) Applicant: Hitachi, Ltd., Tokyo (JP)

(72) Inventor: Kiyotaka TAKAHASHI, Tokyo (JP)

(21) Appl. No.: 19/539,550

(22) Filed: Feb. 13, 2026

(30) Foreign Application Priority Data
Apr. 25, 2025 (JP) 2025-073723

(51) Int. Cl. G06Q 10/06; G06Q 10/0633

(52) U.S. Cl. CPC G06Q 10/06; G06Q 10/0633

(57) ABSTRACT

A business process management device specifies a series of tasks set as a replacement range in a current business process data, specifies input data and a task name of a task at an input end of the series of tasks set as the replacement range and output data and a task name of a task at an output end of the series of tasks set as the replacement range, and retrieves similar business process data including a replacement candidate range for replacing the series of tasks set as the replacement range, based on input data coincident with or similar to the input data of the task at the input end of the series of tasks set as the replacement range, a task name coincident with or similar to a task name of an input-side adjacent task in a preceding stage adjacent to the task at the input end, output data coincident with or similar to the output data of the task at the output end of the series of tasks set as the replacement range, and a task name coincident with or similar to a task name of an output-side adjacent task in a subsequent stage adjacent to the task at the output end.

### CLAIM OF PRIORITY

The present application claims priority from Japanese patent application JP 2025-073723 filed on Apr. 25, 2025, the content of which is hereby incorporated by reference into this application.

### BACKGROUND OF THE INVENTION

### 1. Field of the Invention

The present invention relates to a business process management device and a business process management method.

### 2. Description of Related Art

Management of a business process is performed using a computer for the purpose of achieving goals and improving efficiency for an organization through automation of processes and effective use of information.

The following prior art is included as background art in the technical field. PTL 1 (JP2016-105247A) discloses a data analysis case retrieval system including: a business process component database in which a partial business and a target object constituting a target business of a business improvement project are collected; an input reception unit that receives, for an improvement target business, the partial business and the target object constituting the improvement target business based on the business process component database; a case database that accumulates, for a past business improvement case, a partial business, a target object, and a used solution constituting the past business improvement case; a case retrieval unit that compares an index included in the partial business and the target object constituting the input improvement target business with an index included in the partial business and the target object constituting the business improvement case accumulated in the case database, and that determines similarity therebetween; and an output unit that presents a business improvement case determined to have similarity to the input improvement target business.

### CITATION LIST

### Patent Literature

PTL 1: JP2016-105247A

### SUMMARY OF THE INVENTION

In the related art, even when business processes that have been proposed to implement digital transformation (DX) through collaborative creation with a customer are accumulated, it is not easy to reuse and effectively utilize the business processes. In an environment of a customer, some solution is operating in many cases regardless of a host company or another company, and a new business process is created (constructed) by improving the business process in operation. At this time, it is required to effectively utilize (reuse) business processes accumulated by the host company.

However, information related to a plurality of elements constituting the business process is not prepared to be processed by a computer. Therefore, the reuse of accumulated business processes depends on human skills. For example, it is required to manually find parts that can be reused. In addition, since the business process is not managed by being divided into components (elements) constituting business processes, it is difficult to determine a reusable part. The configuration disclosed in PTL 1 has a function of specifying a digital solution that can be applied to a target customer environment (for example, an index (key performance indicator (KPI)) required by a customer can be expected to be improved), but does not have a function of comparing with a current system and reusing the digital solution with a fine granularity. That is, in the current system, a method of providing a solution in which a part that can be utilized in the future is utilized and only a lacking part is provided is not assumed. In addition, a business process constructed based on a new evaluation index (for example, well-being and planetary boundaries) that has not been used so far is not a candidate to be applied.

The invention has been made to solve the above problems. That is, an object of the invention is to provide a business process management device and a business process management method that can effectively utilize accumulated business processes by specifying a part to be reused in a task unit for the accumulated business processes.

A representative example of the invention disclosed in the present application is as follows. That is, a business process management device is implemented by a computer including a processor that executes a program and a storage unit. The storage unit stores business process data including a plurality of tasks. The processor receives an input of current business process data, specifies a series of tasks set as a replacement range in the current business process data, specifies input data and a task name of a task at an input end of the series of tasks set as the replacement range and output data and a task name of a task at an output end of the series of tasks set as the replacement range, and retrieves, from business processes accumulated in the storage unit, similar business process data including a replacement candidate range for replacing the series of tasks set as the replacement range, based on input data coincident with or similar to the input data of the task at the input end of the series of tasks set as the replacement range, a task name coincident with or similar to a task name of an input-side adjacent task in a preceding stage adjacent to the task at the input end, output data coincident with or similar to the output data of the task at the output end of the series of tasks set as the replacement range, and a task name coincident with or similar to a task name of an output-side adjacent task in a subsequent stage adjacent to the task at the output end.

According to an aspect of the invention, it is possible to select a new business process applicable to the current business process of a customer from an accumulated business process group. Problems, configurations, and effects other than those described above will be clarified by the following description of an embodiment.

### BRIEF DESCRIPTION OF THE DRAWINGS

FIG. 1 is a system configuration diagram according to an embodiment of the invention.

FIG. 2 illustrates a business process table.

FIG. 3 illustrates a business process task table.

FIG. 4 illustrates a boundary combination candidate task table.

FIG. 5 is a diagram illustrating a drawing expression of a business process.

FIG. 6 is a diagram illustrating a structure of a drawn business process (example).

FIG. 7 is a diagram illustrating adjacent tasks in a drawn business process (example).

FIG. 8A is a diagram illustrating a drawn similar business process candidate.

FIG. 8B is a diagram illustrating a drawn similar business process candidate.

FIG. 9 is a flowchart showing a processing flow for finding and selecting a replaceable business process.

FIG. 10 is a flowchart showing a processing flow for inputting a business environment.

FIG. 11 is a flowchart of a processing flow for inputting a current business process.

FIG. 12 is a flowchart of a processing flow for specifying a task boundary.

FIG. 13 is a flowchart of a processing flow for specifying an adjacent task (input/output) outside a replacement target range.

FIG. 14A is a flowchart of a processing flow for rearranging replacement candidates according to a predetermined criterion.

FIG. 14B is a flowchart of a processing flow for rearranging replacement candidates according to a predetermined criterion.

FIG. 14C is a flowchart of a processing flow for rearranging replacement candidates according to a predetermined criterion.

FIG. 14D is a flowchart of a processing flow for rearranging replacement candidates according to a predetermined criterion.

FIG. 15A is a diagram illustrating an example of a user interface for inputting a business process.

FIG. 15B is a diagram illustrating an example of a user interface for inputting a business process.

FIG. 15C is a diagram illustrating an example of a user interface for inputting a business process.

FIG. 15D is a diagram illustrating an example of a user interface for inputting a business process.

FIG. 15E is a diagram illustrating an example of a user interface for inputting a business process.

FIG. 16A is a diagram illustrating an example of a user interface for manually selecting a boundary in selection of input and output (boundary).

FIG. 16B is a diagram illustrating an example of a user interface for manually selecting a boundary in selection of input and output (boundary).

FIG. 16C is a diagram illustrating an example of a user interface for manually selecting a boundary in selection of input and output (boundary).

FIG. 16D is a diagram illustrating an example of a user interface for manually selecting a boundary in selection of input and output (boundary).

FIG. 16E is a diagram illustrating an example of a user interface for manually selecting a boundary in selection of input and output (boundary).

FIG. 16F is a diagram illustrating an example of a user interface for manually selecting a boundary in selection of input and output (boundary).

### DESCRIPTION OF EMBODIMENTS

Hereinafter, embodiments of the invention will be described with reference to the drawings. In the drawings of the embodiments, the same or corresponding parts may be denoted by the same reference signs. In the following description, although various types of information may be described by expressions such as “table” and “list”, the various types of information may be expressed by other data structures. Further, although expressions such as “identifier” and “name” are used when describing identification information, the expressions can be replaced with one another, and other expressions may be used. Further, in the following description, although processing may be described using a functional block as a subject, the subject of the processing may be a CPU or a device instead of the functional block.

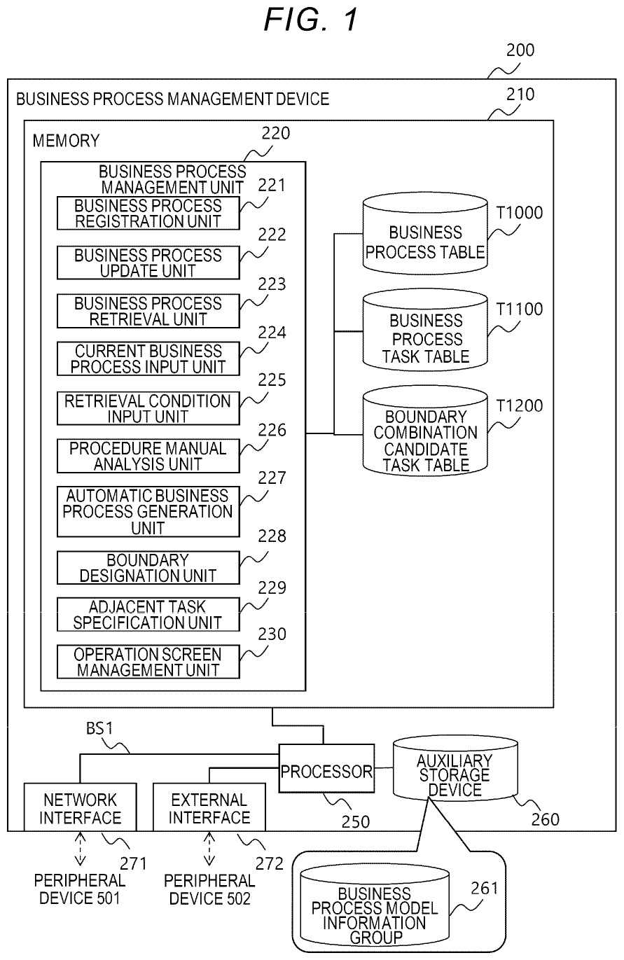

A business process management device 200 according to an embodiment of the invention will be described. FIG. 1 is a diagram illustrating a configuration example of the business process management device 200 according to the embodiment of the invention. As illustrated in FIG. 1, the business process management device 200 includes a memory 210, a processor 250, an auxiliary storage device 260, a network interface 271, and an external interface 272. These components are communicably connected to one another via a bus BS1.

The device including the memory 210, the processor 250, the auxiliary storage device 260, the network interface 271, the external interface 272, and the bus BS1 may be referred to as an “information processing device”. The information processing device may be a plurality of information processing devices or a virtual information processing device constructed on a cloud.

The memory 210 is a storage unit implemented by a semiconductor storage device such as a random access memory (RAM), and temporarily stores a program, which is loaded from the auxiliary storage device 260 to be executed by the processor 250, and necessary data.

The memory 210 includes a business process management unit 220 as a program. The business process management unit 220 includes a business process registration unit 221, a business process update unit 222, a business process retrieval unit 223, a current business process input unit 224, a retrieval condition input unit 225, a procedure manual analysis unit 226, an automatic business process generation unit 227, a boundary designation unit 228, an adjacent task specification unit 229, and an operation screen management unit 230. These programs are, for example, loaded from the auxiliary storage device 260 into the memory 210 and executed by the processor 250, thereby implementing various functions.

For example, the business process registration unit 221 registers (stores) information on a business process represented by BPMN in various tables (a business process table T1000 and a business process task table T1100) and a business process model information group 261. The business process update unit 222 updates and deletes the information on the business process stored in the various tables and the business process model information group 261. The business process retrieval unit 223 retrieves a business process based on information of a procedure manual or based on a retrieval condition or the like designated by a user via the retrieval condition input unit 225.

The current business process input unit 224 inputs information on a current business process in order to retrieve the business process. The retrieval condition input unit 225 inputs a retrieval condition for retrieving a new business process. The procedure manual analysis unit 226 reads and analyzes the description of the procedure manual to be referred to when a task performer executes a target business process in order to automatically extract and present a candidate for a boundary of tasks constituting a business process of interest when retrieving the new business process. Instead of manually input information on a business process one piece by one piece in the current business process input unit 224, the automatic business process generation unit 227 constructs information necessary for expressing as a series of tasks constituting the business process by using information on a task group constituting the business process extracted by the procedure manual analysis unit 226, and generates the business process.

The boundary designation unit 228 retrieves a replaceable business process from business processes accumulated in the business process table T1000 for the business process input by the user through the current business process input unit 224, and designates, as a retrieval condition, two or more boundary candidates serving as end points of a series of tasks in order to specify a series of tasks as a replacement range. With respect to a boundary candidate serving as an end point of a series of tasks as a retrieval condition designated by the boundary designation unit 228, the adjacent task specification unit 229 specifies an adjacent task (input-side adjacent task) immediately before the start task when the end point corresponds to the start of the series of tasks, or an adjacent task (output-side adjacent task) immediately after the end task when the end point corresponds to the end of the series of tasks. The operation screen management unit 230 performs display control of an operation screen that is a GUI screen to be output and displayed to a first peripheral device 501 or a second peripheral device 502.

Further, the memory 210 includes the business process table T1000, the business process task table T1100, and a boundary combination candidate task table T1200. The business process table T1000, the business process task table T1100, and the boundary combination candidate task table T1200 are used when executing a program. For example, these tables are stored in the auxiliary storage device 260, and are loaded from the auxiliary storage device 260 into the memory 210 and temporarily stored therein when executing the program. Details of the business process table T1000, the business process task table T1100, and the boundary combination candidate task table T1200 will be described later.

The processor 250 executes a program stored in the memory 210. For example, the processor 250 loads the program stored in the auxiliary storage device 260 into the memory 210. The processor 250 implements each function of the business process management unit 220 by executing predetermined operational processing by the program loaded in the memory 210.

The auxiliary storage device 260 is a storage unit including a non-volatile storage device capable of reading and writing data. The auxiliary storage device 260 stores (holds) programs executed by the processor 250 and data used by the processor 250.

The auxiliary storage device 260 stores the business process model information group 261. The business process model information group 261 includes a plurality of business process models related to a plurality of business processes. The business process model includes information indicating a plurality of tasks constituting a business process, an order of the plurality of tasks, and data (for example, information on input and output) used in the tasks. Model information identifiers for identifying the business process models are assigned to the plurality of business process models.

The network interface 271 is an interface for connecting the business process management device 200 to a network (not illustrated). The business process management device 200 is connected to the first peripheral device 501 via the network. The first peripheral device 501 is a user terminal (for example, a personal computer (PC), a smartphone, or a tablet) used by the user.

The external interface 272 is an interface for connecting the second peripheral device 502. The second peripheral device 502 is an operation device such as a keyboard and a mouse, a display, or the like.

The program executed by the processor 250 is provided to the business process management device 200 via a removable medium (CD-ROM, flash memory, or the like) or the network, and is stored in the non-volatile auxiliary storage device 260 that is a non-transitory storage medium. Therefore, the business process management device 200 may include an interface for reading data from the removable medium.

The business process management device 200 is a computer system implemented on one physical computer or a plurality of computers implemented logically or physically, and may operate on a virtual computer constructed on a plurality of physical computer resources. For example, each functional unit may operate on a separate physical or logical computer, or a combination of a plurality of functional units may operate on one physical or logical computer.

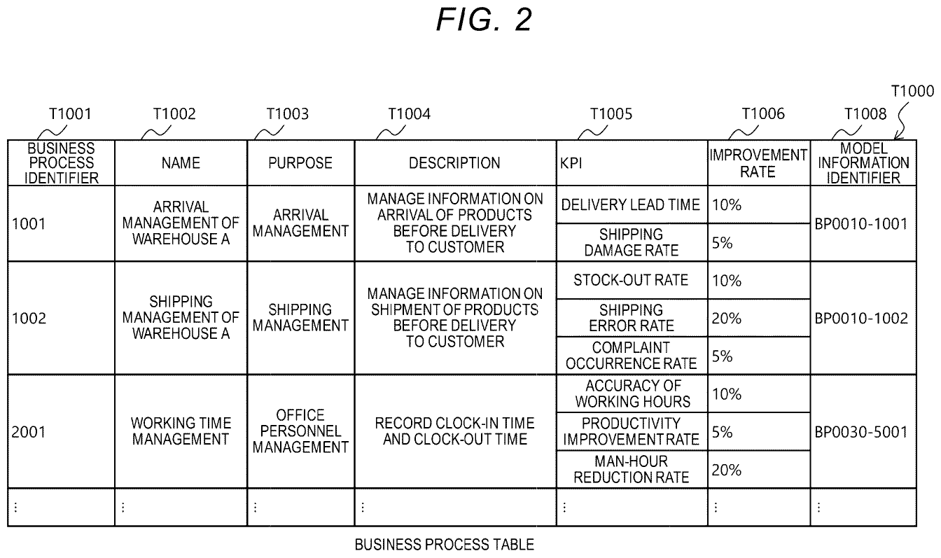

FIG. 2 illustrates the business process table T1000. As illustrated in FIG. 2, the business process table T1000 includes, as columns for storing information (values), a business process identifier T1001, a name T1002, a purpose T1003, a description T1004, a key performance indicator (KPI) T1005, an improvement rate T1006 as an actual result of introduction of the business process, a failure and defect count T1007, and a model information identifier T1008. In the business process table T1000, information corresponding to columns related to business processes is associated with one another and stored as information (records) in units of rows.

Specifically, the business process identifier T1001 stores an identifier for identifying a business process. The name T1002 stores a name of the business process. The purpose T1003 stores a purpose of the business process. The description T1004 stores a description of the business process (business process description). The KPI T1005 stores a name of an index (KPI) improved by the business process identified by the business process identifier T1001. The improvement rate T1006 stores a numerical value indicating a ratio at which an index value that is the KPI T1005 is improved by applying the business process identified by the business process identifier T1001. The failure and defect count T1007 stores a numerical value indicating the number of failures and defects caused by the application of the business process identified by the business process identifier T1001. The model information identifier T1008 stores a model information identifier of a business process model corresponding to the business process. The business process table T1000 may be referred to as “business process information” for convenience.

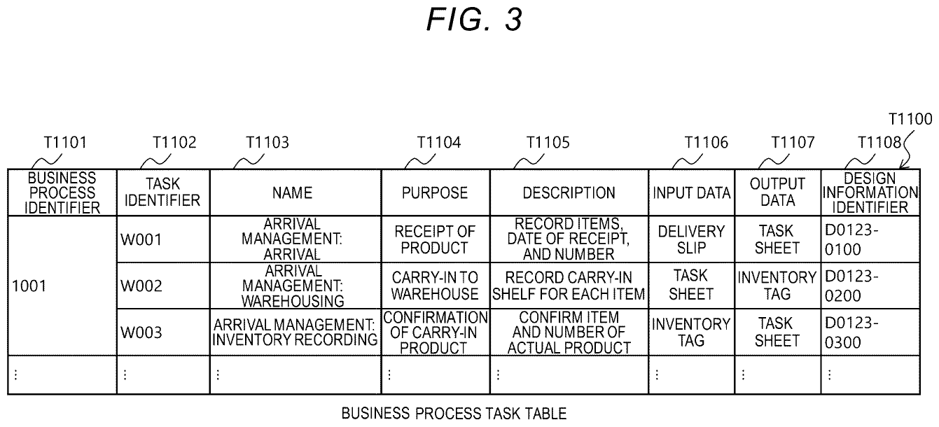

FIG. 3 illustrates the business process task table T1100. The business process task table T1100 describes the content of task for each business process identifier. As illustrated in FIG. 3, the business process task table T1100 includes, as columns for storing information (values), a business process identifier T1101, a task identifier T1102, a name T1103, a purpose T1104, a description T1105, input data T1106, output data T1107, and a design information identifier T1108. In the business process task table T1100, information corresponding to columns related to tasks constituting the business process is associated with one another and stored as information (records) in units of rows.

Specifically, the business process identifier T1101 stores an identifier of a corresponding business process. The task identifier T1102 stores an identifier for identifying a task constituting the corresponding business process. The name T1103 stores a name of the task. The purpose T1104 stores a purpose of the task. The description T1105 stores a description (task description) related to the task. The input data T1106 stores a name of data that is given as an input of the task. The output data T1107 stores a name of data that is output as a result of performing the task. The design information identifier T1108 stores an identifier for identifying design information corresponding to the task. The business process task table T1100 may be referred to as “task information” for convenience of description.

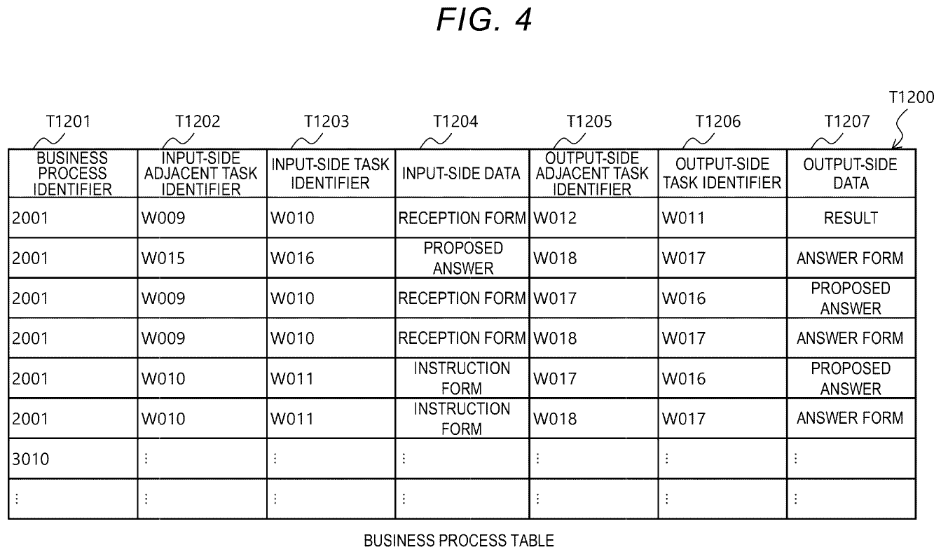

FIG. 4 illustrates the boundary combination candidate task table T1200. As illustrated in FIG. 4, the boundary combination candidate task table T1200 includes, as columns for storing information (values), a business process identifier T1201, an input-side adjacent task identifier T1202, an input-side task identifier T1203, input-side data T1204, an output-side adjacent task identifier T1205, an output-side task identifier T1206, and output-side data T1207. In the boundary combination candidate task table T1200, information on a combination pattern of two boundaries on the input side and the output side of a series of tasks, which are candidates when retrieving a business process, is stored as information (record) in units of rows.

Specifically, the boundary combination candidate task table T1200 stores information on a combination pattern of two boundaries on the input side and the output side of a series of tasks that are candidates when retrieving a new business process. The business process identifier T1201 stores an identifier for identifying a current business process for which retrieval is performed. The input-side adjacent task identifier T1202 stores an identifier for identifying a task adjacent to an input-side task in a combination of boundaries of a business process indicated by the record. The input-side task identifier T1203 stores an identifier for identifying the input-side task in the combination of the boundaries of the business process indicated by the record. The input-side data T1204 stores a name of data given to the input-side task in the combination of the boundaries of the business process indicated by the record. The output-side adjacent task identifier T1205 stores an identifier for identifying a task adjacent to an output-side task in the combination of the boundaries of the business process indicated by the record. The output-side task identifier T1206 stores an identifier for identifying the output-side task in the combination of the boundaries of the business process indicated by the record. The output-side data T1207 stores a name of data output from the output-side task in the combination of the boundaries of the business process indicated by the record.

The business process is a series of a plurality of tasks for achieving a specific purpose or a business goal, and can be expressed by the plurality of tasks, contents of the tasks, a structure of the plurality of tasks (a flow of the tasks), or the like. The tasks are elements constituting the business process. The business process is managed using the business process table T1000, the business process task table T1100, and the business process model information group 261. In the following description, for convenience, a set of information on one business process included in the information (tables) may be referred to as “business process data”. A plurality of pieces of business process data stored in the business process management device 200 may be referred to as “accumulated business process data group”. The accumulated business process data group includes, for each of a plurality of business processes accumulated in the business process management device 200, the business process information (the business process table T1000) for describing contents of the business process, the task information (the business process task table T1100) for describing contents of tasks constituting the business process, and data (the business process model information group 261) associated with the business process.

When the user improves a current business process, the business process management device 200 is used. The business process management device 200 acquires current business process data related to the current business process. Then, the business process management device 200 acquires information on a boundary between tasks in the series of tasks constituting the current business process, thereby acquiring information on a range that the user considers to be replaceable with an accumulated business process in order to improve the business process. The accumulated business process data includes business process information including a name of the accumulated business process, a purpose, and a business process description, and information on the KPI indicating what has been improved to what extent when the business process is applied compared to before the application and an improvement rate thereof. Accumulated business process task information includes accumulated task information including a name, a purpose, and a task description of a task constituting the accumulated business process, information of data given as an input to the task, and information of data output by performing the task. The current business process data includes business process information including a name, a purpose, and a business process description of the current business process. Current business process task information includes current task information including a name, a purpose, and a task description of a task constituting the current business process, information of data given as an input to the task, and information of data output by performing the task.

The business process management device 200 retrieves a business process suitable for (highly likely to be suitable for) the current business process and a business environment (hereinafter, referred to as a “similar business process”) from the business process model information group 261 held (stored) in the auxiliary storage device 260. Specifically, current task information, boundary information, and a keyword (also referred to as a “first keyword”) extracted from the name, the purpose, and the business process description related to the current business process are used. Reference is made to information on the following elements for the current business process: a series of tasks to be candidates for a new business process to be replaced by an accumulated business process, data given to an input-side task of the series of tasks, an input-side adjacent task that is adjacent to the input-side task and outputs the data, data output from an output-side task of the series of tasks, and an output-side adjacent task that is adjacent to the output-side task and receives the data as an input. Further, from the accumulated business process data group, all accumulated business process data, in which a keyword same as the first keyword or a keyword registered as its synonym in a synonym dictionary (not shown) and regarded as the same is included in the name, purpose, and business process description of the business process and in which the input-side adjacent task, the input-side data, the output-side data, and the output-side adjacent task are coincident with or similar to those of the current business process, is retrieved as similar business process candidates suitable for the current business process and the business environment.

The business process management device 200 prioritizes similar business process candidates among a plurality of similar business process candidates found as a result of the retrieval according to, for example, the following conditions:
the improvement rate (the actual result value of the improved KPI for each application case shown in the T1006 column in FIG. 2) of the business when the business process is applied is high. In particular, the improvement rate of the KPI considered as an issue by the customer is high;
the failure and defect count (the failure and defect count for each application case shown in the T1007 column in FIG. 2) when the business process is applied is small;
in the similar business process candidate, the number of task names (for example, a task name registered as a synonym in a synonym dictionary (not illustrated)) coincident with or similar to task names included in tasks handling an output from tasks handling an input from the current business process is large; and
when the similar business process candidate includes two or more task names (for example, registered as a synonym in a synonym dictionary (not illustrated)) coincident with or similar to task names included in tasks handling an output from tasks handing an input from the current business process, the order in which the task names appear in the similar business process candidate is coincident with the order of the task names included in the current business process.

As described above, when the user constructs a new business process (for example, a new business process obtained based on the current business process by improving the current business process), the business process management device 200 can specify a similar business process suitable for the current business process and the business environment from the business processes accumulated in the business process management device 200, and can improve the business by replacing some of the tasks constituting the current business process with some tasks constituting the similar business process. Accordingly, the business process management device 200 can support the user to construct (create) a new business process by effectively utilizing, in units of tasks, the current business process and the accumulated business processes.

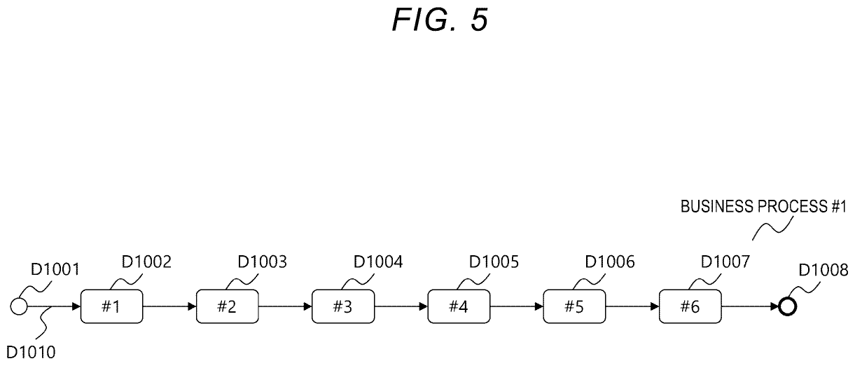

A method of visualizing a business process is standardized by, for example, International Standard business process model and notation (BPMN, ISO/IEC19510), and is also known as a business process modeling notation method. This is a method of schematizing steps and procedures from the start to the end of a certain business in a flow format. FIG. 5 illustrates a general business process. A business process #1includes a task #1 of D1002, a task #2 of D1003, a task #3 of D1004, a task #4 of D1005, a task #5 of D1006, and a task #6 of D1007 that are linked and are executed continuously. In the business process #1, the task #1 is executed following the start D1001, then the task #2 is executed, then the task #3 is executed, then the task #4 is executed, then the task #5 is executed, then the task #6 is executed, and the process ends at the end D1008. Input data is input to each task, and output data is output therefrom. For example, data D1010 input at the start D1001 is input to the task #1 as input data, and output data of the task #1 is input to the task #2 as input data. Output data of the task #2 is input to the task #3 as input data, and output data of the task #3 is input to the task #4 as input data. Similarly, output data of the task #6 is output as output data D1008 of the business process #1.

The procedure manual describes the contents of the tasks constituting the business process, input data, output data, a flow when the tasks are continuously executed in a linked manner, and the like. In the procedure manual, the performer of each task is written. These pieces of information are written in a computer-readable format. The procedure manual may be associated with the business process and include only auxiliary information related to the business process, or may include reproducible complete information related to the business process and generate the business process from the procedure manual.

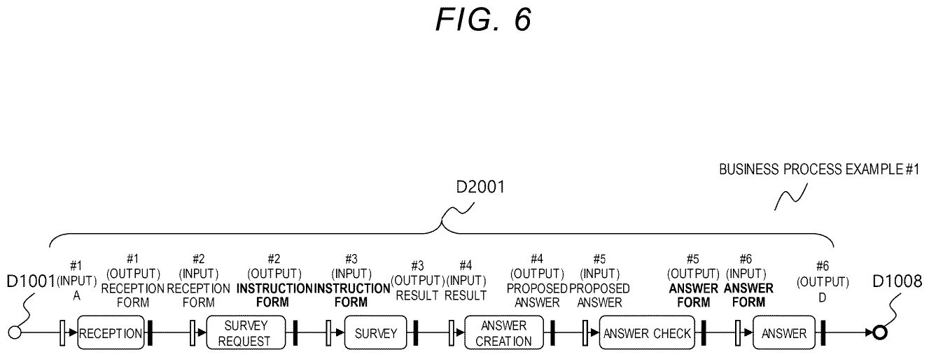

A business process example #1 illustrated in FIG. 6 embodies the business process #1 illustrated in FIG. 5 and illustrates input and output of each task. In the business process examples #1 of D2001, after the input D1001, a task “reception” receives input data A #1 and outputs output data “reception form” #2, then a task “survey request” receives input data “reception form” #2 and outputs output data “instruction form” #2, then a task “survey” receives input data “instruction form” #3 and outputs output data “result” #3, then a task “answer creation” receives input data “result” #4 and outputs output data “proposed answer” #4, then a task “answer check” receives input data “proposed answer” #5 and outputs output data “answer form” #5, then a task “answer” receives input data “answer form” #6 and outputs output data “D” #6, and the process ends with the output D1008. As described above, each task has data to be handled as an input and data to be handled as an output, and the name of each data is indicated. In two adjacent tasks, the name of the output data of the task in the preceding stage coincides with the name of the input data of the task in the subsequent stage.

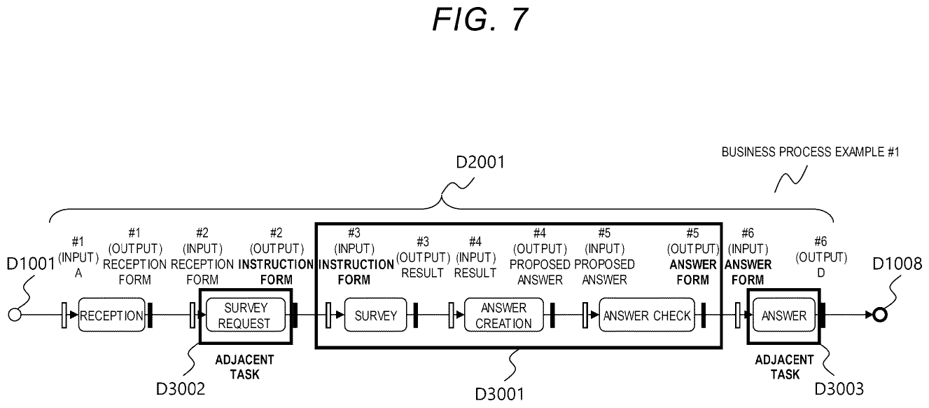

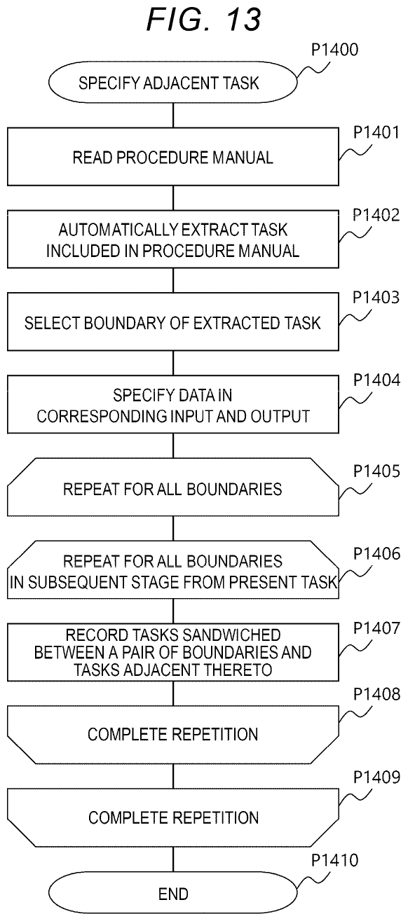

A business process example #1 illustrated in FIG. 7 indicates portions of interest as a range to be replaced with tasks of a similar business process in order to improve the current business process in the business process example #1 illustrated in FIG. 6. FIG. 7 shows a result of step P1403 of selecting a boundary of extracted tasks in processing of specifying adjacent tasks (input/output) outside a replacement target range, which is described with reference to FIG. 13. Data names of boundaries, which are end points of a series of tasks D3001 indicating a range in which replacement is considered in the business process, and adjacent tasks D3002 and D3003 adjacent to the end points of the series of tasks D3001 are portions of interest. For such a business process example #1, the business process management device 200 retrieves a business process, which includes tasks (a series of tasks) coincident with or similar to the portions of interest, as a similar business process from the accumulated business processes.

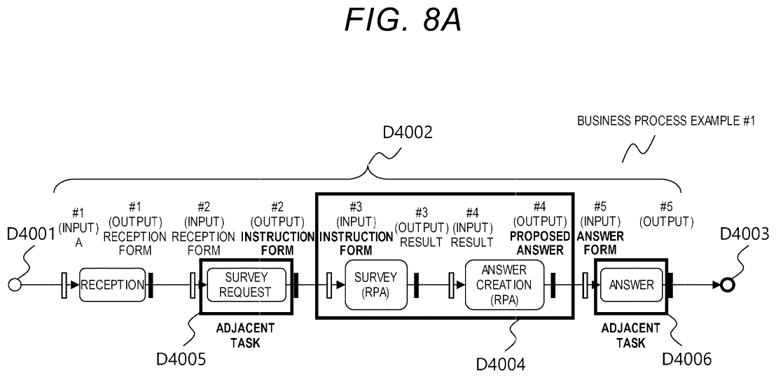

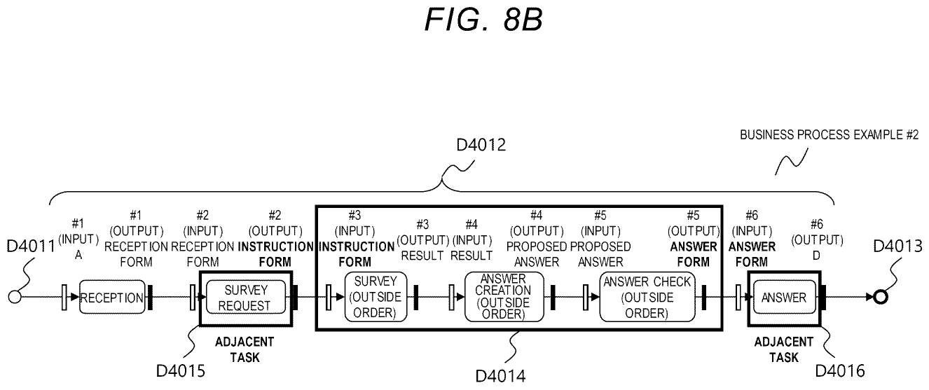

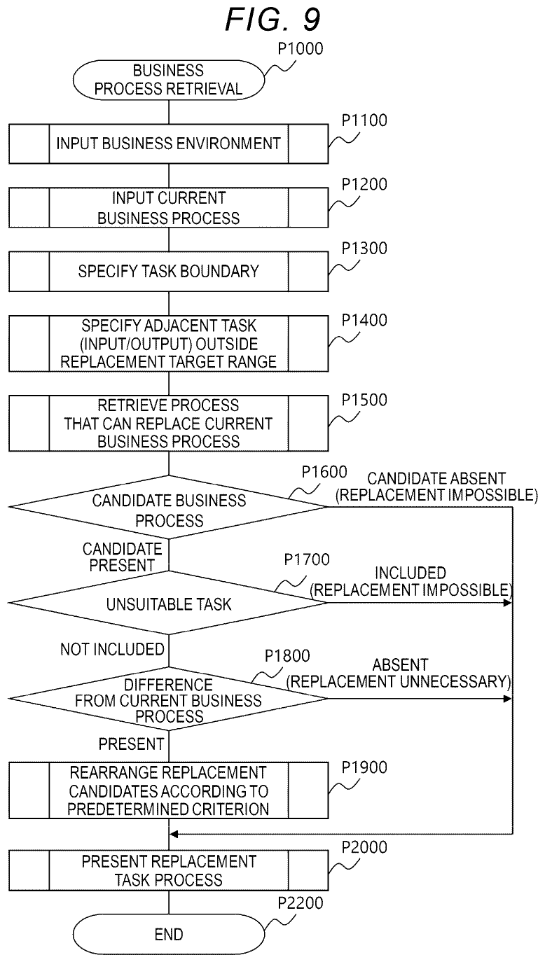

FIGS. 8A and 8B illustrate similar business process examples #1 and #2 found as a result of retrieval by the business process management device 200. These similar business process examples are a result of step P1500 of retrieving a process that can be used to replace the current business process in processing of finding and selecting a replaceable business process, which is described with reference to FIG. 9. Here, as similarity points in terms of form of the current process and the similar business process, data names of boundaries as end points of a series of tasks D4004 and D4014 (in D4004, “instruction form” as input data #3 and “answer form” as output data #4, and in D4014, “instruction form” as input data #3 and “answer form” as output data #5), and adjacent tasks D4005 and D4006 adjacent to the end points of the series of tasks D4004 and adjacent tasks D4015 and D4016 adjacent to the end points of the series of tasks D4014, which indicate the range in which replacement is considered in the business process, are exemplified.

Business processes having an actual result of achieving DX by collaborative creation with leading customers can be accumulated, and when proposing DX to another customer, a new business process can be selected as a candidate applicable to the current business process of the customer from the accumulated business process group. A business process having partially similar business is exemplified as a candidate even if the entire business process is configured for a different purpose. Further, a business process effective for the key performance indicator (KPI), which is not assumed in the current business process, is also exemplified as a candidate. Therefore, an appropriate business process can be retrieved with high accuracy from the accumulated DX experience, and it can be expected to effectively utilize the accumulated DX experience.

### Specific Operations

FIG. 9 is a flowchart showing a processing flow for finding and selecting a replaceable business process, which is executed by the business process retrieval unit 223 of the business process management device 200. First, a business environment is input (step P1100). Thereafter, a current business process is input (step P1200). Thereafter, a task boundary is specified (step P1300). Thereafter, adjacent tasks (input/output) outside a replacement range, that is, an input-side adjacent task and an output-side adjacent task are specified (step P1400). Thereafter, a business process including a replacement candidate range (for example, D4004 in FIG. 8A and D4014 in FIG. 8B), with which the replacement range of the current business process can be replaced, is retrieved as a similar business process (P1500). In step P1500, by using, as retrieval keys, input data (for example, the input data #3 “instruction form” in FIG. 7) of a task serving as an input-side end point in the current business process for which retrieval is performed, an adjacent task name (for example, the task #2 “survey request” in FIG. 7) in the preceding stage that outputs the input data of the task serving as the input-side end point and for which the retrieval is not performed, output data (for example, the output data #5 “answer form” in FIG. 7) of a task serving as an output-side end point, and an adjacent task name (for example, the task #6 “answer” in FIG. 7) in the subsequent stage that receives the output data of the task serving as the output-side end point as an input and for which the retrieval is not performed, a business process including a task (or a series of tasks) coincident with or similar to the retrieval keys is retrieved from accumulated past business processes, and a task group of the past business processes coincident with or similar to the search keys is listed. At this time, it is determined whether a candidate business process is found as a similar business process (step P1600). If no candidate is found, the processing ends (step P2200). If there is a candidate, it is determined whether an unsuitable task is included (step P1700). If an unsuitable task is included, the processing ends (step P2200). If no unsuitable task is included, it is determined whether there is a difference from the current business process (step P1800). If there is no difference from the current business process, there is no benefit for replacement, and the processing is ended (step P2200). If there is a difference, the processing proceeds to subsequent processing. With the above processing, when there is a possibility of being suitable for the current business process and a similar business process having a difference is found, replacement candidates are rearranged according to a predetermined criterion (step P1900). Then, a replacement business process is presented (step P2000).

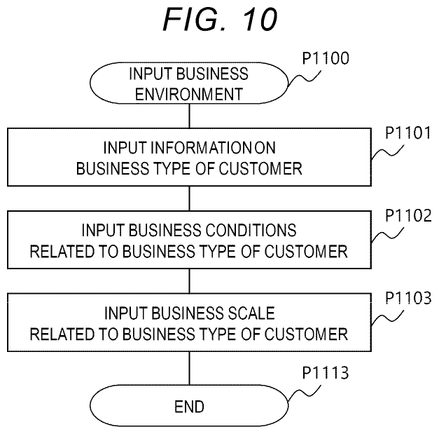

FIG. 10 is a flowchart showing a processing flow (step P1100 in FIG. 9) for the business environment input P1100, which is executed by the retrieval condition input unit 225 of the business process management device 200. First, in step P1101 of inputting information on a business type of a customer, information indicating the business type of the customer is input. Next, in step P1102 of inputting business conditions related to the business type of the customer, information on the business conditions is input. Finally, in step P1103 of inputting a business scale related to the business type of the customer, information on the business scale is input. These steps of processing may be replaced by extracting keywords associated with the business environment (for example, keywords related to the business type, the business conditions, the business scale, and an investment amount) from the name, purpose, and business process description of the current business process. Regarding the business type, businesses related to automobiles (design, manufacture, and sale of automobiles), businesses related to chemistry (manufacture of chemical products such as petrochemical products, pharmaceuticals, agricultural chemicals, and plastics), businesses related to electronic and electrical machines (manufacture of electronic devices and electrical products such as computers, smartphones, and home appliances), businesses related to foods and beverages (production, processing and sale of foods and beverages, such as processing of agricultural products, production of beverages, and packaging of foods), and the like are considered. Regarding the business conditions, in the manufacturing field, mass production (for example, mass production of automobiles in a large-scale factory), production to order (for example, production of special products dedicated to customers based on orders from customers), process manufacture (for example, production of products using chemical reactions such as petrochemical products and pharmaceuticals), assembly manufacture (for example, completion of products by assembling components of machines and electronic devices), and the like are considered. Regarding the business scale, the number of employees, the sales amount, the number of bases such as factories and business offices, the production amount of products, and the like are considered. The business type, the business conditions, and the business scale are used to determine the similarity when retrieving accumulated past business processes. The investment amount is the amount of money that can be invested for improving the current business process, and is compared with the amount of money for implementing a listed past business process when retrieving the accumulated past business processes. When there is a large deviation between the two amounts (for example, when the investment amount is large to be equal to or larger than a predetermined amount of money), the listed past business process is not treated as a candidate, or the investment amount is used as an index for lowering the priority. The business process can be improved according to an investment budget.

FIG. 11 is a flowchart showing a processing flow (step P1200 in FIG. 9) for inputting a current business process, which is executed by the current business process input unit 224 of the business process management device 200. First, information on the current business process (for example, the name, the purpose of implementation, and the description of the business process) is input (step P1201). Next, the user determines whether there is data describing the business process (for example, data described in BPMN, computer-readable business process design data) (step P1202). If there is data describing the business process, the data is read (step P1217), and the processing ends. If there is no data describing the business process, it is determined whether there is a task procedure manual describing a procedure of tasks performed in the business process (step P1203). If there is no task procedure manual data describing the task procedure of the business process, the user manually inputs connection relationships of all the tasks constituting the business process (for example, connection relationships of the tasks of the business process illustrated in FIG. 7) (step P1212). The input data corresponds to, for example, data of one row of the business process table illustrated in FIG. 2. Then, explanatory information (for example, data of the columns T1002 to T1008 in the business process table illustrated in FIG. 2) about the task is input (step P1214). The processing of step P1214 is repeated for all the tasks (steps P1213 and P1216), and the processing ends.

In step P1203, if there is data describing the task procedure of the business process, the procedure manual is read (step P1204). The procedure manual is read by reading text data about a document such as a procedure manual or a manual in which a task procedure or a handling method is described, a flowchart, or the like into a memory of the business process management device. Then, the task is automatically extracted from the read procedure manual (step P1205). For example, natural language processing is performed, tokens such as words and sentences are extracted from the read text data, parts of speech of nouns and verbs are tagged to each word, and the structure of the sentence is analyzed. For example, a verb plus noun pattern is found and extracted as one task. Accordingly, even when there is no business process data, the business process data can be generated based on the procedure manual. When extracting the task from the procedure manual or the like, a hit rate of the retrieval can be increased by extracting the task at a fine granularity in preparation for the retrieval of the accumulated past business process. If the procedure manual is written for a non-expert, it is assumed that a task instruction is written in detail and carefully, and thus it is sufficient to extract the task according to description content. On the other hand, if the procedure manual is written for an expert, it is assumed that a series of tasks are described as instructions having a high abstraction level and a rough granularity. By combining with information described in another procedure manual, a manual, or the like, a described instruction having a rough granularity can be replaced with an instruction having a fine granularity, so that a task having a fine granularity can be extracted. In addition, a task procedure by a plurality of task performer may be described in the procedure manual. For example, in a case where a series of tasks to be performed by two task performers are extracted as one task, it may be difficult to know affected task performers and boundaries of steps when applied to the site, and it may be difficult to operate. In such a case, the granularity of the task to be extracted may be determined so as to extract the task for each task performer assumed in the procedure manual. For example, a boundary of a business process considered as an issue by a customer may be used as a boundary for division. All the extracted tasks are selected to be drawn as a business process (step P1206). From an anteroposterior relationship of the selected tasks, the connection relationships of all the selected tasks are automatically drawn in the BPMN format using a representation method for modeling a business process such as BPMN (step P1207). With reference to the procedure manual or the manual for task, dependency structure analysis is performed on peripheral words or sentences in which a token for extracting the task is described, structures of the sentences are analyzed, and a relationship between the sentences is clarified. An explanatory sentence usually provides supplementary information for a main sentence. By analyzing a dependency relationship between the sentences to specify which sentence explains which sentence, explanatory information of the sentence indicating the task is input (step P1209), and information on the task content extracted in the previous processing is input as a definition of business process information described in the BPMN format or the like (step P1210). Steps P1209 and P1210 are repeated for all the tasks (steps P1208 and P1211), and the processing ends.

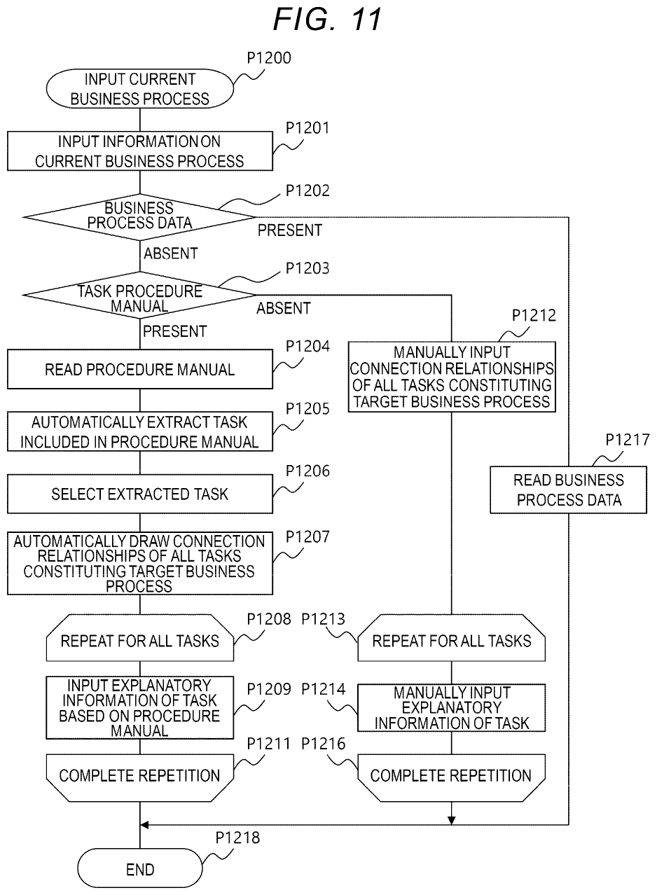

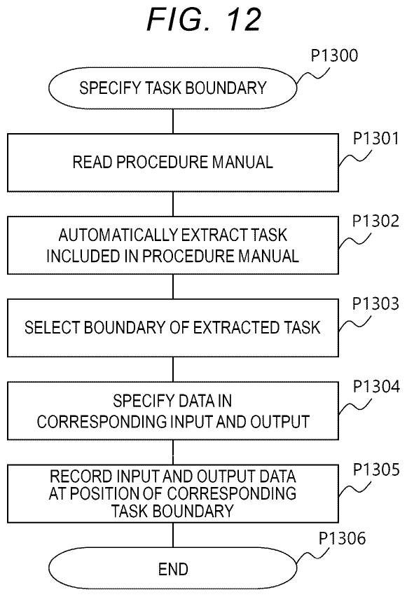

FIG. 12 is a flowchart showing a processing flow (step P1300 in FIG. 9) for specifying a task boundary, which is executed by the business process management device 200. This processing is processing for automatically extracting and setting a boundary between tasks, which indicates a range in which replacement is considered in a business process, by using a procedure manual related to the business process in which a task procedure is described in a company unique format, instead of being manually designated by the user. First, a procedure manual related to a target business flow is read (step P1301). Then, for example, the procedure manual analysis unit 226 of the business process management device 200 analyzes information described in the procedure manual and automatically extracts tasks (step P1302). For example, the boundary designation unit 228 of the business process management device 200 indicates boundaries of the extracted tasks to the user and causes the user to select a boundary as a condition for retrieving a business process (step P1303). After all the boundaries are selected, data names handled at the boundaries are specified (step P1304). The data is specified, for example, by referring to a data name dictionary (not illustrated) in which input and output data items, data names, and the like are described. Then, input and output data is recorded at the position of a corresponding task boundary (step P1305), and the processing is ended (step P1306). For the selection of the boundary, the procedure manual may be analyzed, and the business process management device 200 may propose a boundary to the user so as to be approved by the user based on some criterion (for example, (1) in a case where it is assumed that a lump of tasks including a plurality of tasks are assigned to a task performer, the efficiency of the business process after replacement may be further improved by not providing a boundary in an intermediate task constituting the lump, and (2) in accordance with a proficiency level of the task performer in charge of a task, tasks may be finely divided to lower the difficulty of a series of tasks when a non-expert is in charge, and a plurality of tasks may be combined to increase the difficulty of a series of tasks when an expert is in charge, thereby improving the efficiency of the business process according to the proficiency level of the task performer), thereby assisting the user in the task.

FIG. 13 is a flowchart showing a processing flow for specifying an adjacent task (input/output) outside the replacement target range, which is executed by the adjacent task specification unit 229 of the business process management device 200. This processing is processing for automatically extracting and setting tasks adjacent to an input side and an output side at boundaries between tasks, which indicates a range in which replacement is considered in a business process, by using a procedure manual related to the business process, instead of being manually designated by a user. First, a procedure manual related to a target business flow is read (step P1401). Then, information described in the procedure manual is analyzed to automatically extract tasks (step P1402). A boundary of the extracted tasks is shown to the user, and the user is allowed to select a boundary as a condition for retrieving a business process (step P1403). As a result of this processing, the chart of FIG. 7 is obtained. After all the boundaries are selected, data names handled at the boundaries are specified (step P1404). Based on these pieces of information, the following processing is repeated for all the boundaries (step P1405). Further, the following processing is repeated for a boundary located at a subsequent stage of the currently selected task (step P1406). A series of tasks sandwiched between two selected boundaries and tasks adjacent to the input side and the output side of the series of tasks are recorded (step P1407). Accordingly, the boundary combination candidate task table T1200 illustrated in FIG. 4 is constructed in which all combinations of the input-side adjacent task, the input-side task, the input-side data name, the output-side adjacent task, the output-side task, and the output-side data name for which retrieval is performed are recorded.

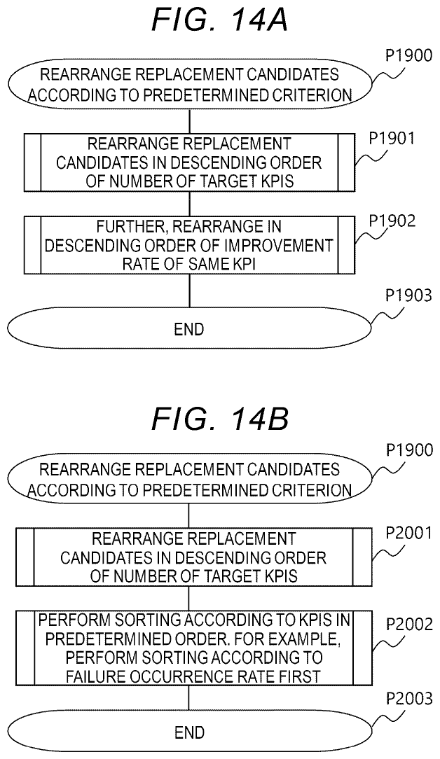

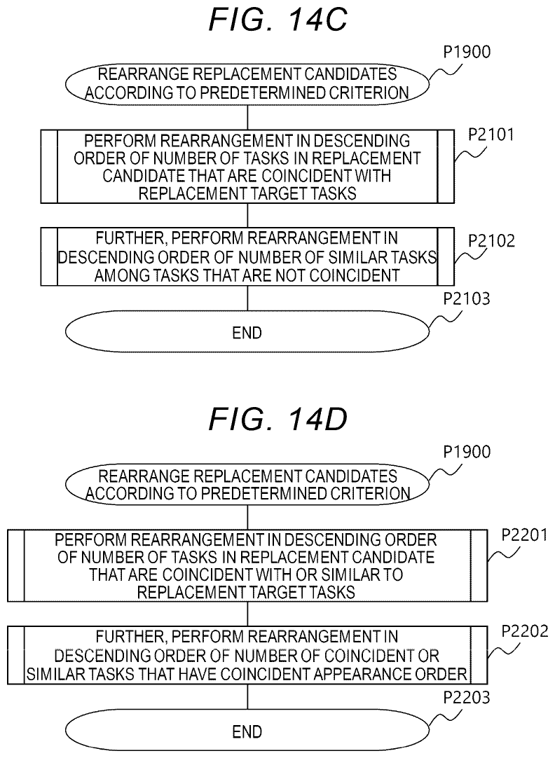

FIGS. 14A to 14D are flowcharts showing processing flows for rearranging replacement candidates according to a predetermined criterion, which is executed by the business process retrieval unit 223 of the business process management device 200. These processing flows are executed as processing (step P1900 in FIG. 9) of rearranging, based on actual result values of improvement rates of the replacement candidates, the similar business process group extracted from the accumulated business processes by the processing from the business environment input (step P1100) to the determination (step P1800) of the presence or absence of the difference from the current business process in the business process retrieval P1000 in FIG. 9.

FIG. 14A is a flowchart illustrating rearrangement of the replacement candidates based on the KPI improvement rate. When there are various improvement points as a reference of rearrangement, the replacement candidates are sorted in descending order of the number of KPIs expected to be improved by replacement for the business process (step P1901). Further, when the number of KPIs is the same and there is the same common KPI, a comparison is made for the improvement degree of each KPI, and a process having a high improvement degree of production efficiency is prioritized. When there is no common KPI, a comparison is made for the total of ratios of KPIs to be improved, and a process having a high total is prioritized. When the number and the ratio of the KPIs to be improved are equal, the priority is determined in alphabetical order of the business process name (step P1902). In this way, for example, replacement for a business process that greatly improves the KPI considered as an issue by a customer can be performed. As a specific example, when a business process A has an improvement of 30% in production efficiency and an improvement of 20% in defect rate and a business process B has an improvement of 20% in production efficiency and an improvement of 20% in defect rate, the business process A having a higher degree of improvement in production efficiency by 10% is prioritized. When the business process A has an improvement of 30% in production efficiency and an improvement of 5% in defect rate and the business process B has an improvement of 20% in production efficiency and an improvement of 30% in task time, the production efficiency that is a common KPI is of interest, and the business process A having a higher improvement degree by 10% is prioritized. Further, when the business process A has an improvement of 30% in production efficiency and an improvement of 20% in defect rate and the business process B has an improvement of 10% in failure rate and an improvement of 30% in task time, there is no common KPI, but a comparison is made for the total of the KPIs to be improved. Since 50% for the business process A is higher than 40% for the business process B by 10%, the business process A is prioritized. Finally, when the business process A and the business process B have improvements in the same number of KPIs and have equal totals of ratios of the KPIs to be improved, the priority is determined in the alphabetical order of the business process name and the business process A is prioritized.

In FIG. 14B, an occurrence rate of failures that occur after the replacement for the business processes is taken into consideration as a reference for rearrangement. First, similarly to the processing in FIG. 14A, the replacement candidates are sorted in descending order of the number of KPIs expected to be improved by the replacement for the business process (step P2001). Thereafter, the sorting is performed according to the KPIs in a predetermined order. For example, the sorting is performed according to a failure occurrence rate first (step P2002). Accordingly, the failure occurrence rate after replacement can be reduced.

FIG. 14C is a flowchart showing a processing flow for rearranging the replacement candidates according to a ratio of similar tasks constituting the replacement candidates, which is executed by the business process retrieval unit 223 of the business process management device 200. A series of tasks of the replacement target are compared with a series of tasks constituting each replacement candidate in terms of name, the number of tasks whose names are coincident with those of the tasks of the replacement target is counted, and the replacement candidates are sorted in descending order of the number of tasks having coincident names (step P2101). Thereafter, among the replacement candidates, with respect to replacement candidates having the same number of tasks whose names are coincident with those of the tasks of the replacement target, the tasks of the replacement target and the tasks of the replacement candidates are compared again in terms of names that are not coincident, the number of tasks having names similar to those of the replacement target is counted, and the replacement candidates are rearranged in descending order of the number of tasks having similar names (step P2102). For example, in a case where the maximum number of tasks constituting the business process of the replacement target and the business process of the replacement candidate is less than 100, zero is set as the value of a priority counter of all the replacement candidates in step P2100, and 100 is added to the priority counter of the replacement candidate every time a task having the name coincident with of the name of the task of the replacement target is found for each replacement candidate in P2101. In step P2102, for each replacement candidate, 1 is added to the priority counter of the replacement candidate every time a task having a name similar to the name of the task of the replacement target is found. When the processing is completed for all the replacement candidates, a value having a magnitude corresponding to the ratio of the similar tasks is stored in the priority counter of each replacement candidate. As the number of tasks having coincident names increases, the change from the current business process can be performed more smoothly.

FIG. 14D is a flowchart showing a processing flow for rearranging the replacement candidates according to the degree of coincidence of the order of the similar tasks constituting the replacement candidates, which is executed by the business process retrieval unit 223 of the business process management device 200. A series of tasks of the replacement target are compared with a series of tasks constituting each replacement candidate in terms of name, the number of tasks whose names are coincident with or similar to those of the replacement target is counted, and the replacement candidates are sorted in descending order of the number of tasks having coincident or similar names (step P2201). Thereafter, with respect to replacement candidates having the same number of tasks whose names are coincident with or similar to those of the tasks of the replacement target among the replacement candidates, for the coincident or similar task names, the appearance order of the corresponding tasks of the replacement target from the input side of the business process and the appearance order of the tasks of the replacement candidate from the input side of the business process are compared, and the replacement candidates are sorted in descending order of the number of coincidence in the appearance order (step P2202). For example, in a case where the replacement target is composed of four tasks [A, B, C, D], a replacement candidate 1 is [A, B, C, N], a replacement candidate 2 is [H, F, T, E], and a replacement candidate 3 is [A, C, B, U], since the replacement candidate 1 and the replacement candidate 3 each include three tasks having names coincident with those of the tasks of the replacement target, the replacement candidate 1 and the replacement candidate 3 have the same ratio at the time of step P2201. The appearance order of the three coincident tasks A, B, and C in the replacement candidate 1 is the same as the appearance order in the replacement target, whereas the appearance order of the coincident tasks C and B in the replacement candidate 3 is opposite to and different from that in the replacement target, and thus the replacement candidate 1 is arranged higher and the replacement candidate 3 is arranged lower by the processing of step P2202. As the number of tasks having coincident appearance order increases, the replacement from the current business process can be performed more smoothly.

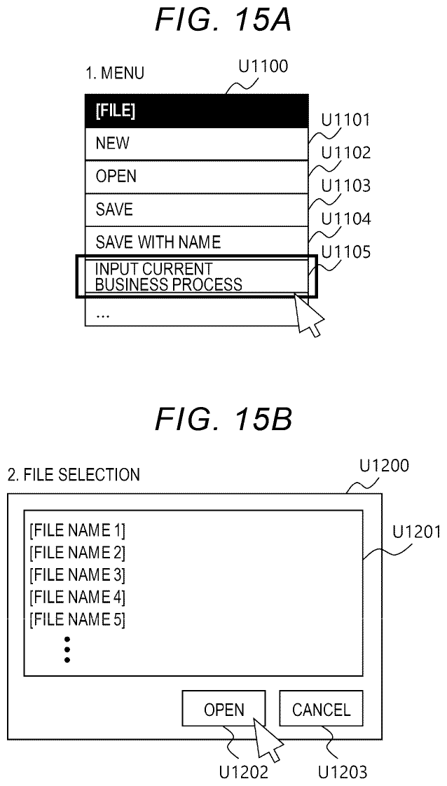

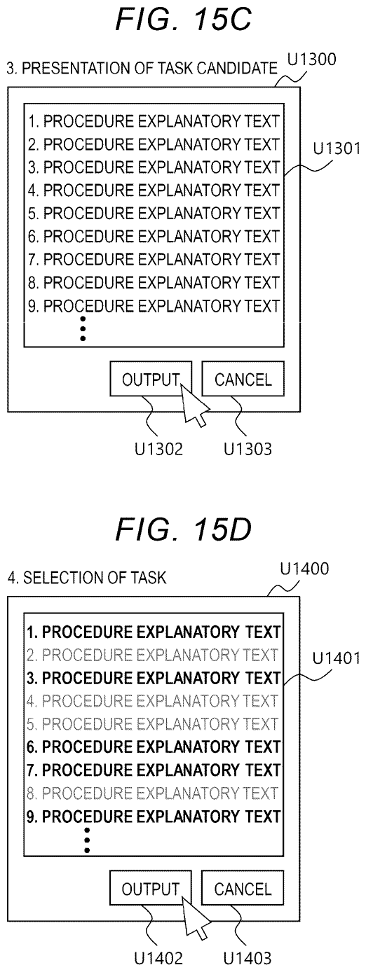

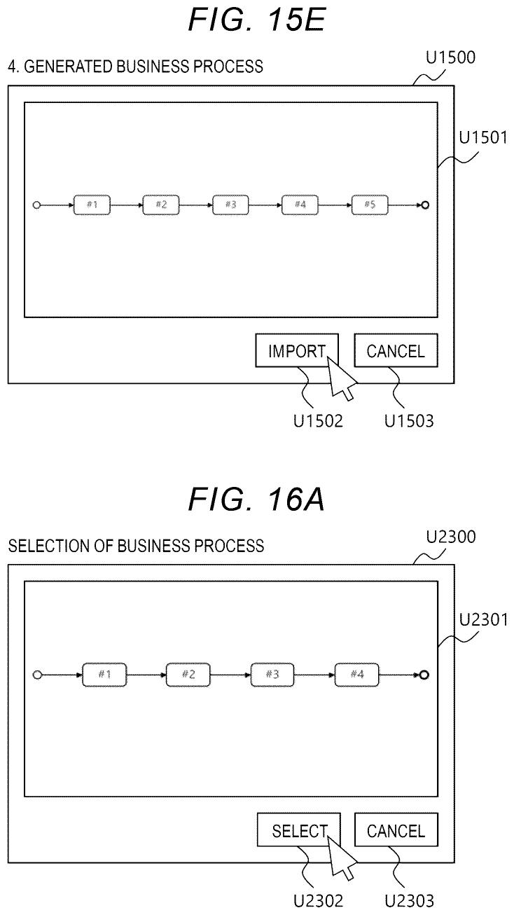

FIGS. 15A to 15E illustrate an example of an input method with reference to a procedure manual of a business process via a graphical user interface in processing (FIG. 11) of inputting a current business process, which is executed by the current business process input unit 224 of the business process management device 200. FIG. 15A illustrates a menu U1100 of the UI. The menu U1100 includes “New” U1101, “Open” U1102, “Save” U1103, “Save with Name” U1104, and “Input Current Business Process” U1105 for operating a file. The user selects “Input Current Business Process” U1105 from the menu. Here, it is assumed that there is no business process data (“NO” in step P1202 in FIG. 11). A dialog for selecting a file of a task procedure manual to be read is displayed.

FIG. 15B illustrates an example U1200 of the displayed dialog. The dialog U1200 includes a list U1201 of files of task procedure manuals to be read, an “Open” button U1202 for opening a selected file, and a button U1203 for canceling reading. The user selects a desired file from the dialog U1200 and operates the “Open” button U1202 to read the file of the task procedure manual.

The read task procedure manual is analyzed, and a dialog U1300 for presenting a list of explanatory texts of one or more tasks recognized to be drawn as the business process illustrated in FIG. 15C is displayed (step P1205 in FIG. 11). FIG. 15C includes a view U1301 for displaying a list of presented explanatory texts of tasks, an “Output” button U1302 for outputting a selected explanatory text, and a “Cancel” button U1303 indicating cancellation. The user selects all explanatory texts of task to be drawn as tasks constituting the business process from among the presented explanatory texts of tasks, and operates the “Output” button U1302.

In FIG. 15D, the selected explanatory texts of tasks are indicated in bolt as “x. Procedure Explanatory Text” in a view U1401 for displaying a list of the explanatory texts. U1400, U1401, U1402, and U1403 in FIG. 15D correspond to U1300, U1301, U1302, and U1303 in FIG. 15C, respectively. As a result of operating the “Output” button U1302, a business process in which one or more selected (step P1206 in FIG. 11) “x. Procedure Explanatory Text” are taken as tasks is drawn and presented.

FIG. 15E illustrates a dialog U1500 for displaying the business process to be drawn and presented, and illustrates a view U1501 of the business process, an “Import” button U1502, and a “Cancel” button U1503. If there is no problem with the presented business process, the user operates the “Import” button U1502 to import data of the business process into the business process management device 200 as data of the current business process and automatically draw connection relationships of all the tasks constituting the target business process (step P1207 in FIG. 11).

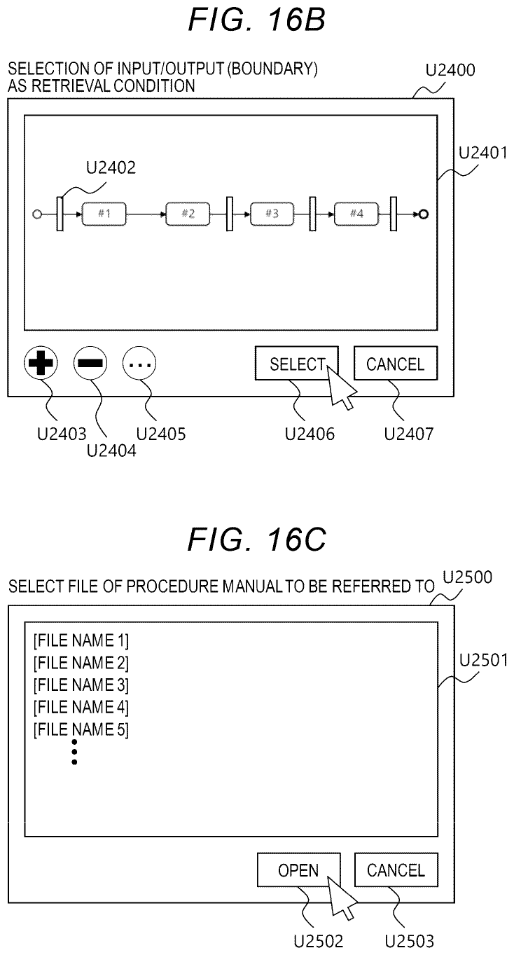

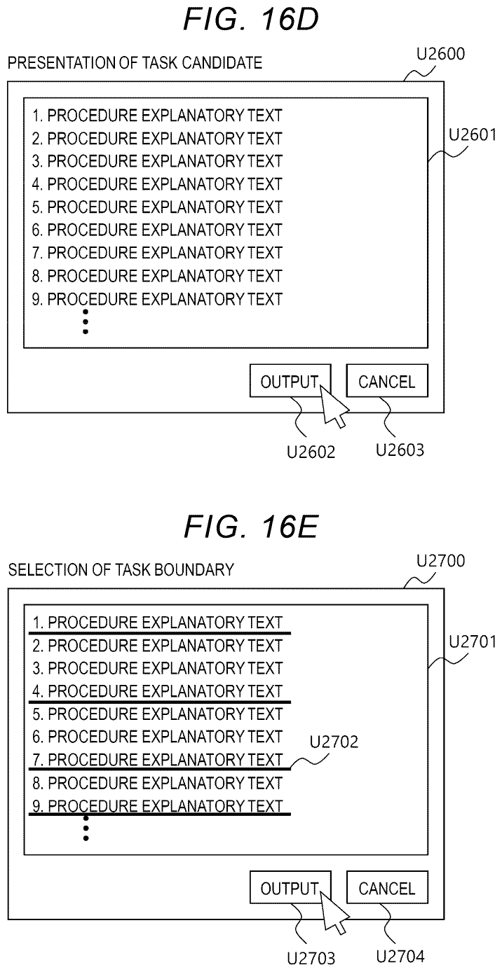

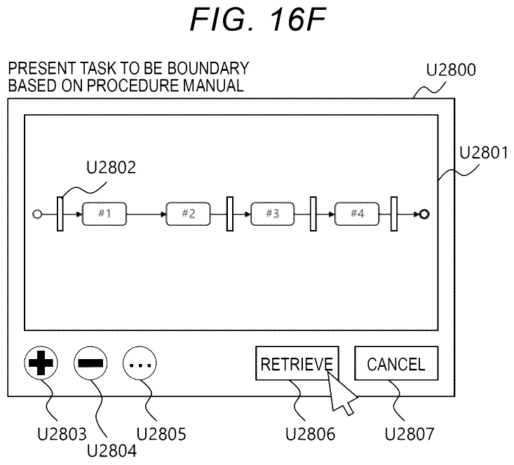

FIGS. 16A and 16B illustrate an example of a method of selecting a boundary via a graphical user interface in processing of specifying a task boundary, which is executed by the boundary designation unit 228 of the business process management device 200. FIGS. 16A and 16B are an example used when the user manually selects a boundary on the business process in the case where there is no business process data (“NO” in step P1202) and there is no task procedure manual (“NO” in step P1203) in the processing of inputting the current business process in FIG. 11. When the user manually inputs the connection relationships of all the tasks constituting the target business process, the business process is displayed as in a view U2301 of FIG. 16A. FIG. 16A further includes a “Select” button U2302 and a “Cancel” button U2303. When selecting a boundary for the displayed business process, the “Select” button U2302 is operated.

FIG. 16B illustrates a dialog U2400 for selecting a boundary by operating the “Select” button U2302 in the dialog U2300, and includes a button (indicated by “+”) U2403 for adding a boundary, a button (indicated by “−”) for deleting a boundary, and a button (indicated by “. . . ”) U2405 for designating another action. In the dialog U2400, the user operates the add button U2403 or the delete button U2404 to select an action of adding or deleting a boundary, and then can manually select a boundary between tasks on the displayed business process. In addition, a proficiency level of a task performer to whom the task is assigned may be input, and the degree of division of the task may be changed according to the input proficiency level.

FIG. 16C illustrates a dialog U2500, and the dialog U2500 includes a view U2501 for file names, an “Open” button U2502, and a “Cancel” button U2503. Here, when the user selects a desired procedure manual file and operates the “Open” button U2502, the selected procedure manual is read. Accordingly, the business process management device 200 analyzes the read procedure manual and presents a list of explanatory texts of one or more tasks recognized to be drawn as a business process (step P1302 in FIG. 12).

FIG. 16D illustrates a dialog U2600 of the presented explanatory texts of the tasks, and the dialog U2600 includes a view U2601 for the procedure explanatory text, an “Output” button U2602, and a “Cancel” button U2603. Here, the user checks each presented “x. Procedure Explanatory Text” and operates, on the screen, a portion to be set as the boundary, thereby causing a line U2702 indicating a boundary to be displayed on the screen as illustrated in FIG. 16E. Thereafter, by operating an “Output” button U2703, the business process is displayed together with a mark U2802 indicating the boundary at the selected portion of the boundary.

FIG. 16F illustrates a diagram U2800 showing a business process having a mark indicating a boundary, and the diagram U2800 includes a view U2801 showing the business process and the mark U2802 indicating the boundary, a button (indicated by “+”) U2803 for adding a boundary, a button (indicated by “−”) U2804 for deleting a boundary, a button (indicated by “. . . ”) U2805 for designating another action, a “Retrieve” button U2806, and a “Cancel” button U2807.

The invention is not limited to the embodiment described above, and includes various modifications and equivalent configurations within the scope of the appended claims. For example, the embodiment described above has been described in detail to facilitate understanding of the invention, and the invention is not limited to those including all the configurations described above. A part of a configuration of one embodiment may be replaced with a configuration of another embodiment. A configuration of another embodiment may be added to a configuration of one embodiment. Another configuration may be added to a part of the configuration of each embodiment, and a part of the configuration of each embodiment may be deleted or replaced with another configuration.

A part or all of the configurations, functions, processing units, processing methods, and the like described above may be implemented by hardware by, for example, designing with an integrated circuit, or may be implemented by software by, for example, a processor interpreting and executing a program for implementing each function.

Information such as a program, a table, and a file for implementing each function can be stored in a storage device such as a memory, a hard disk, or a solid state drive (SSD), or can be stored in a recording medium such as an IC card, an SD card, or a DVD.

Control lines and information lines considered to be necessary for description are illustrated, and not all control lines and information lines necessary for implementation are illustrated. Actually, almost all configurations may be considered to be connected to one another.

What is claimed is:

1. A business process management device implemented by a computer including a processor that executes a program and a storage unit, wherein
the storage unit stores business process data including a plurality of tasks, and
the processor
receives an input of current business process data,
specifies a series of tasks set as a replacement range in the current business process data,
specifies input data and a task name of a task at an input end of the series of tasks set as the replacement range and output data and a task name of a task at an output end of the series of tasks set as the replacement range, and
retrieves, from business processes accumulated in the storage unit, similar business process data including a replacement candidate range for replacing the series of tasks set as the replacement range, based on input data coincident with or similar to the input data of the task at the input end of the series of tasks set as the replacement range, a task name coincident with or similar to a task name of an input-side adjacent task in a preceding stage adjacent to the task at the input end, output data coincident with or similar to the output data of the task at the output end of the series of tasks set as the replacement range, and a task name coincident with or similar to a task name of an output-side adjacent task in a subsequent stage adjacent to the task at the output end.

2. The business process management device according to claim 1, wherein
the processor specifies a series of tasks set as the replacement range for each task performer assumed in a procedure manual.

3. The business process management device according to claim 1, wherein
the processor specifies a series of tasks set as the replacement range based on a boundary of a business process considered as an issue by a customer.

4. The business process management device according to claim 1, wherein
the processor
receives an input of an investment amount regarding a current business process, and
retrieves the similar business process data by excluding business process data in which an investment amount regarding the accumulated business process data is larger than the investment amount regarding the current business process by a predetermined value or more.

5. The business process management device according to claim 1, wherein
the processor
reads a task procedure manual,
extracts a task included in the read task procedure manual, and
generates the current business process data by associating the extracted task.

6. The business process management device according to claim 1, wherein
the processor determines a granularity of division of a task to be extracted according to a proficiency level of a task performer in charge of the task.

7. The business process management device according to claim 1, wherein
the processor
stores an actual result value of a predetermined index of the business process data in the storage unit in association with the business process data, and
rearranges the similar business process data according to the actual result value.

8. The business process management device according to claim 1, wherein
the processor
stores a failure and defect count related to the business process data in the storage unit in association with the business process data, and
rearranges the similar business process data according to an actual result value of the failure and defect count.

9. The business process management device according to claim 1, wherein
the processor compares task names of the series of tasks set as the replacement range with task names of tasks in the replacement candidate range in the similar business process data, and rearranges the similar business process data in descending order of the number of coincident or similar task names.

10. The business process management device according to claim 1, wherein
the processor compares an order of the series of tasks set as the replacement range with an order of tasks in the replacement candidate range in the similar business process data, and rearranges the similar business process data in descending order of the number of coincident or similar tasks having a same appearance order.

11. A business process management method to be executed by a business process management device,
the business process management device being implemented by a computer including a processor that executes a program and a storage unit, the storage unit storing business process data including a plurality of tasks,
the business process management method comprising:
receiving an input of current business process data;
specifying a series of tasks set as a replacement range in the current business process data;
specifying input data and a task name of a task at an input end of the series of tasks set as the replacement range and output data and a task name of a task at an output end of the series of tasks set as the replacement range; and
retrieving, from business processes accumulated in the storage unit, similar business process data including a replacement candidate range for replacing the series of tasks set as the replacement range, based on input data coincident with or similar to the input data of the task at the input end of the series of tasks set as the replacement range, a task name coincident with or similar to a task name of an input-side adjacent task in a preceding stage adjacent to the task at the input end, output data coincident with or similar to the output data of the task at the output end of the series of tasks set as the replacement range, and a task name coincident with or similar to a task name of an output-side adjacent task in a subsequent stage adjacent to the task at the output end.
